(19) United States
(12) Patent Application Publication
(10) Pub. No.: US 2026/0266006 A1
(43) Pub. Date: Sep. 10, 2026

(54) Multiple Function Barrier Tape Holding Device

(71) Applicant: Joe Davis, Eutawville, SC (US)

(72) Inventor: Joe Davis, Eutawville, SC (US)

(21) Appl. No.: 19/072,636

(22) Filed: Mar. 6, 2025

(51) Int. Cl. E01F 13/02; A62C 13/78

(52) U.S. Cl. CPC E01F 13/028; A62C 13/78

(57) ABSTRACT

A multiple function barrier tape holding device holds barrier tape in a variety of surroundings. The device includes a stand bracket coupled to a stand. A head is removably coupled to the stand bracket. A channel extends laterally into and through the head having a narrowing section with a first end of the channel being wider than a second end of the channel. A block is insertable into the channel and can be wrapped with barrier tape extending into and through the channel to secure the barrier tape to the head.

### (b) CROSS-REFERENCE TO RELATED APPLICATIONS

Not applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to barrier tape holding device and more particularly pertains to a new barrier tape holding device for holding barrier tape in a variety of surroundings while providing additional functionality, such as a fire extinguisher location.

### (2) Description of Related Art Including Information Disclosed Under 37 CFR 1.97 and 1.98

The prior art relates to barrier tape holding devices. Known prior art provides for securing of barrier tape but lacks a detachable head, mobile weightable stand, and first extinguisher station.

### (h) BRIEF SUMMARY OF THE INVENTION

An embodiment of the disclosure meets the needs presented above by generally comprising a stand bracket coupled to a stand. A head is removably coupled to the stand bracket. A channel extends laterally into and through the head having a narrowing section with a first end of the channel being wider than a second end of the channel. A block is insertable into the channel and can be wrapped with barrier tape extending into and through the channel to secure the barrier tape to the head.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a multiple function barrier tape holding device according to an embodiment of the disclosure.

FIG. 2 is a partially exploded top front side perspective view of an embodiment of the disclosure.

FIG. 3 is a partially exploded front view of an embodiment of the disclosure.

FIG. 4 is a side view of an embodiment of the disclosure.

FIG. 5 is a side view of an embodiment of the disclosure.

FIG. 6 is a partially exploded rear view of an embodiment of the disclosure.

FIG. 7 is a cross-sectional view of an embodiment of the disclosure taken along line 7-7 of FIG. 1.

FIG. 8 is a cross-sectional view of an embodiment of the disclosure taken along line 8-8 of FIG. 2.

FIG. 9 is a side view of an embodiment of the disclosure.

### (j) DETAILED DESCRIPTION OF THE INVENTION

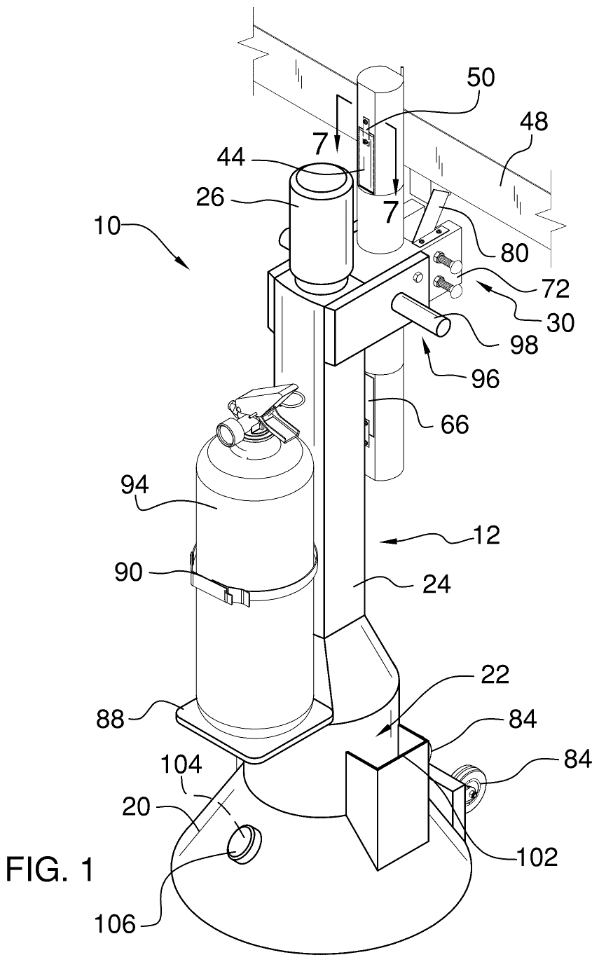

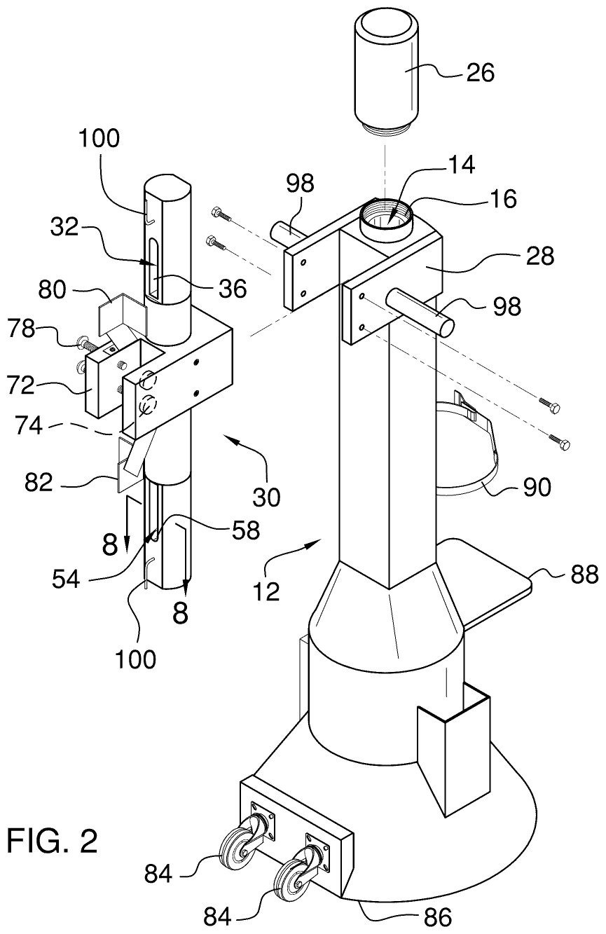

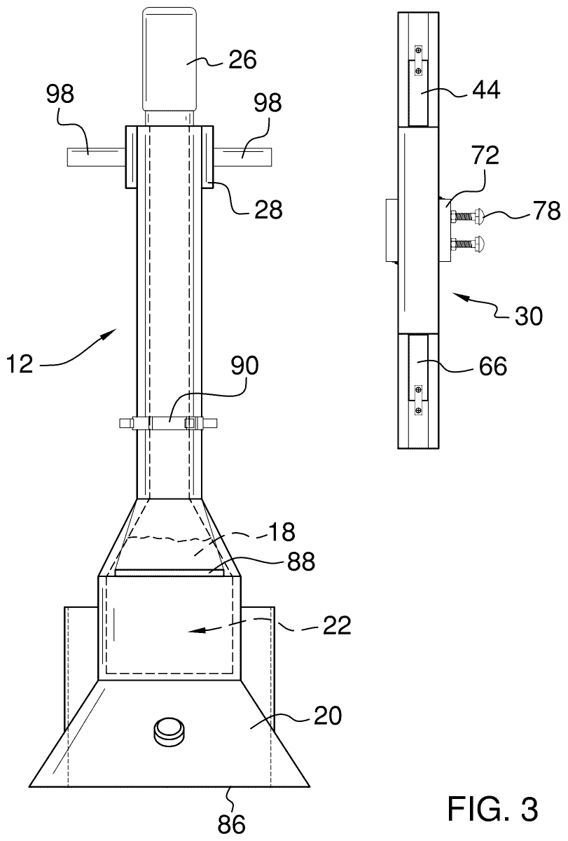

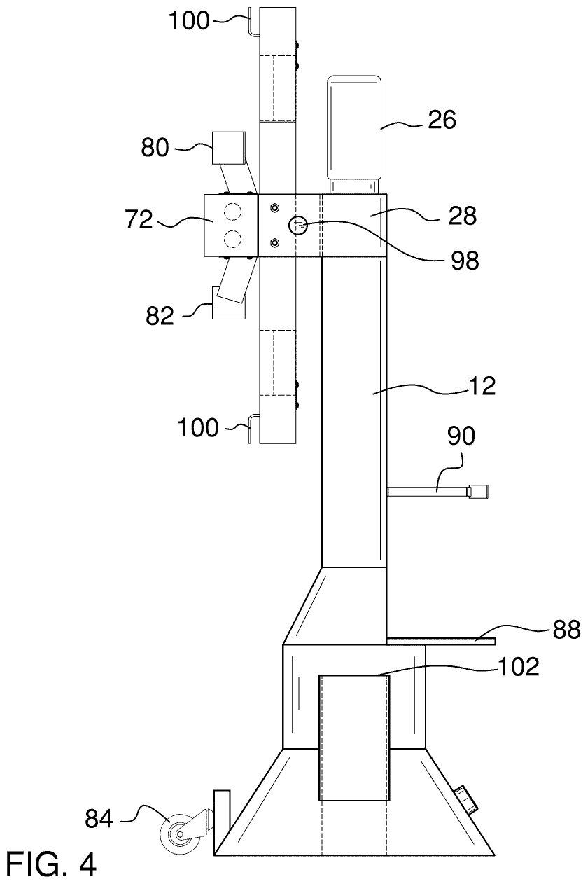

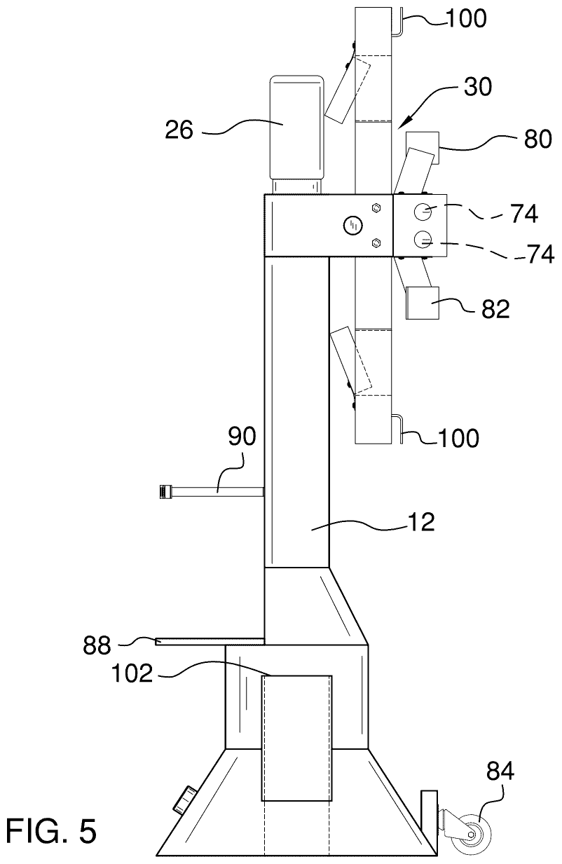

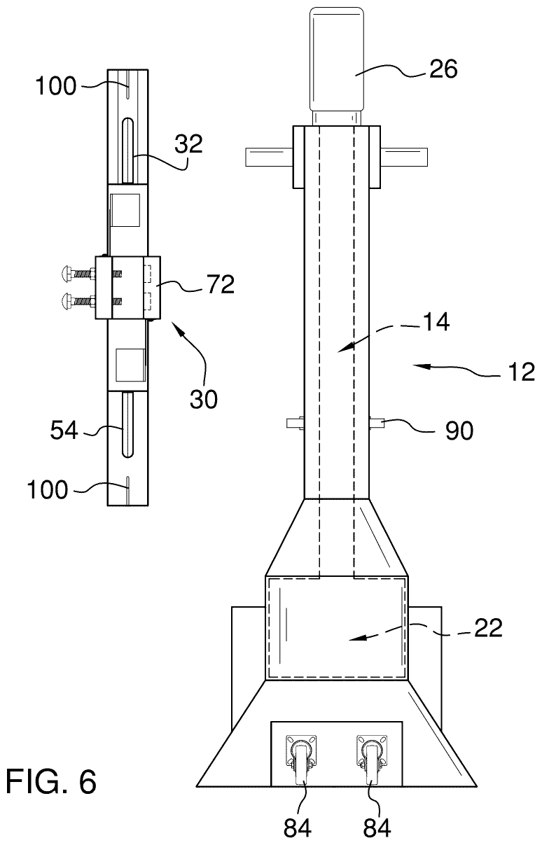

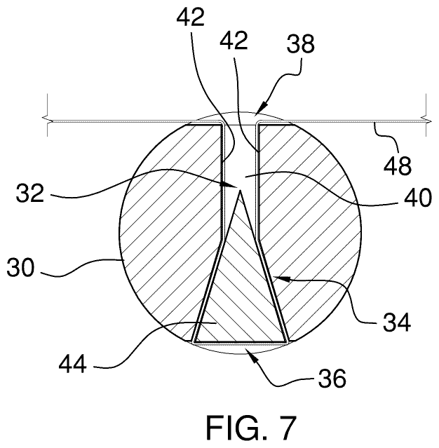

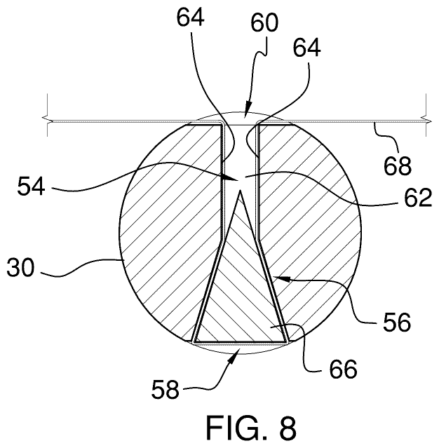

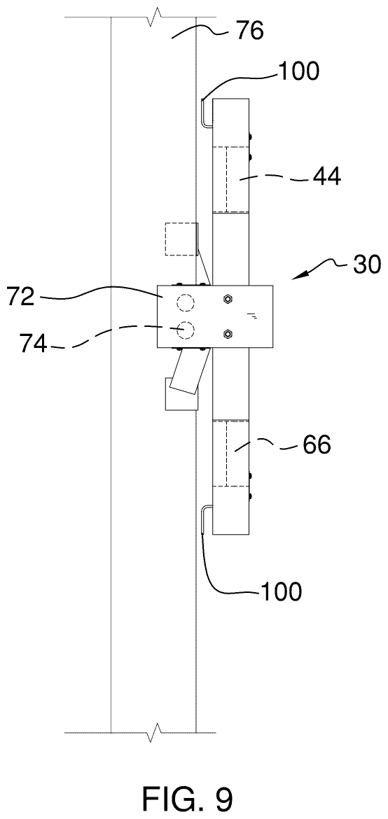

With reference now to the drawings, and in particular to FIGS. 1 through 9 thereof, a new barrier tape holding device embodying the principles and concepts of an embodiment of the disclosure and generally designated by the reference numeral 10 will be described.

As best illustrated in FIGS. 1 through 9, the multiple function barrier tape holding device 10 generally comprises a stand 12 having a hollow interior space 14. The stand 12 has a top opening 16 in fluid communication with the hollow interior space 14 to facilitate filling the hollow interior space 14 with a weighting material 18. A bottom section 20 of the stand 12 is conical to inhibit tipping of the stand 12. The hollow interior space 14 has a cylindrical lowermost section 22 positioned adjacent to and extending upwardly from the bottom section 20 of the stand 12. The lowermost section 22 of the hollow interior space 14 has a diameter greater than a cylindrical upper section 24 of the stand 12. A jar 26 is securable to the top opening 16 by threading for closing the top opening 16 and facilitating gathering, transport, and dispensing of the weighting material 18 if needed. A drain opening 104 may be positioned in the bottom section 20 of the stand 12. The drawn opening 104 may be selectively covered with a drain cap 106.

A stand bracket 28 is coupled to the stand 12. A head 30 is removably coupled to the stand bracket 28. A channel 32 which may be a first channel 32 extends laterally into and through the head 30. The first channel 32 has a narrowing section 34 such that a first end 36 of the first channel 32 is wider than a second end 38 of the first channel 32. The first channel 32 has a straight section 40 defined by parallel surfaces 42 extending from the narrowing section 34 of the first channel 32. A block 44 which may be a first block 44 is insertable into the first end 36 of the first channel 32. The first block 44 has a maximum width greater than a width of the second end 38 of the first channel 32 such that the first block 44 is configured for being wrapped with a first barrier tape 48 extending into and through the first channel 32. Thus, insertion of the first block 44 into the first channel 32 secures the first barrier tape 48 to the head 30 and prevents slippage of the first barrier tape 48 relative to the head 30. The first block 44 has a triangular cross-sectional shape perpendicular to a longitudinal axis of the first block 44 and is complementary to the angling of the narrowing section 34 of the first channel 32. A first tether 50 is coupled between the first block 44 and the head 30. The first tether 50 is sized to extend straight along the stand 12 when the first block 44 is inserted into the first channel 44.

Similarly, a second channel 54 extends laterally into and through the head 30. The second channel 54 has a second channel narrowing section 56 such that a primary end 58 of the second channel 54 is wider than a secondary end 60 of the second channel 54. The second channel 54 has a straight section 62 defined by parallel surfaces 64 extending from the second channel narrowing section 56 of the second channel 54. A second block 66 is insertable into the primary end 58 of the second channel 54. The second block 66 has a maximum width greater than a width of the secondary end 60 of the second channel 54. Thus, the second block 66 is configured for being wrapped with a second barrier tape 68 extending into and through the second channel 54 such that insertion of the second block 66 into the second channel 54 secures the second barrier tape 68 to the head 30. The second block 66 is similarly structured to have a triangular cross-sectional shape perpendicular to a longitudinal axis of the second block 66.

A head bracket 72 is positioned between the first channel 44 and the second channel 54. A magnet 74 is positioned within the head 30 in the head bracket 72 for magnetic connection to a metal support structure 76 such as an I-beam. Multiple magnets 74 may be used. Further, a bolt 78 is threaded through the head bracket 72 such that the bolt 78 is configured for tightening onto the support structure 76 when the support structure 76 is positioned within the head bracket 72. Additionally, an upper angle iron 80 is coupled to the head 30 and a lower angle iron 82 is coupled to the head 30 to align with a surface of the support structure 76 to provide bracing and generally enhance security of the attachment of the head 30 to the support structure 76, such as when engaged directly to the I-beam.

The stand 12 may have additional functionality. A pair of wheels 84 is coupled to the bottom section 20 of the stand 12. The wheels 84 are positioned extending perpendicularly relative to a bottom surface 86 of the bottom section 20 of the stand 12. A platform 88 is coupled to and extends laterally from the stand 12 opposite of the wheels 84. A ring 90 coupled to and extends laterally from the stand 12. The ring 90 is positioned vertically aligned above the platform 88 for encircling a fire extinguisher 94 positioned on the platform 88. A handle 96 is coupled to and extends laterally relative to the stand 12. The handle 96 includes a pair of grips 98 linearly aligned and extending from opposite sides of the stand bracket 28. Each of a pair of hooks 100 is coupled to and extends from the head 30. Each of the hooks 100 is positioned adjacent to a respective one of the first end 36 of the first channel 32 and the primary end 58 of the second channel 54. A pair of wells 102 may extend laterally from the cylindrical lowermost section 22 and through into the bottom section 20 of the stand 12. Each well 102 is sized to be complementary to a 2×4 board.

In use, the first barrier tape 48 and/or the second barrier tape 68 may be secured to the head 30. The head 30 may be attached to the stand 12, or disengaged from the stand 12 to allow for connection of the head 30 to the support structure 56.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A barrier tape holding device comprising:
a stand;
a stand bracket coupled to said stand;
a head removably coupled to said stand bracket;
a channel extending laterally into and through said head, said channel having a narrowing section such that a first end of said channel is wider than a second end of said channel; and
a block, said block being insertable into said first end of said channel, said block having a maximum width greater than a width of said second end of said channel wherein said block is configured for being wrapped with barrier tape extending into and through said channel whereby insertion of said block into said channel is configured to secure the barrier tape to said head.

2. The barrier tape holding device of claim 1, further comprising said block having a triangular cross-sectional shape perpendicular to a longitudinal axis of said block, said channel having a straight section defined by parallel surfaces extending from said narrowing section of said channel.

3. The barrier tape holding device of claim 1, further comprising a tether coupled between said block and said head.

4. The barrier tape holding device of claim 1, further comprising:
said channel being a first channel and said block being a first block; and
a second channel extending laterally into and through said head, said second channel having a second channel narrowing section such that a primary end of said second channel is wider than a secondary end of said second channel; and
a second block, said second block being insertable into said primary end of said second channel, said second block having a maximum width greater than a width of said secondary end of said second channel wherein said second block is configured for being wrapped with a second barrier tape extending into and through said second channel whereby insertion of said second block into said second channel is configured to secure the second barrier tape to said head.

5. The barrier tape holding device of claim 1, further comprising a magnet being positioned within said head, wherein said head is configured for magnetic connection to a metal support structure.

6. The barrier tape holding device of claim 1, further comprising a bolt being threaded through said head bracket wherein said bolt is configured for tightening onto the support structure when the support stricture is positioned within said head bracket.

7. The barrier tape holding device of claim 1, further comprising:
said stand having a hollow interior space, and
said stand having a top opening, said top opening being in fluid communication with said hollow interior space wherein said top opening is configured for insertion of weighting material into said hollow interior for weighting said stand.

8. The barrier tape holding device of claim 7, further comprising a jar, said jar being securable to said top opening for closing said top opening.

9. The barrier tape holding device of claim 1, further comprising a bottom section of said stand being conical.

10. The barrier tape holding device of claim 7, further comprising said hollow interior space having a cylindrical lowermost section positioned adjacent to and extending upwardly from a bottom section of said stand.

11. The barrier tape holding device of claim 10, further comprising said lowermost section of said hollow interior space having a diameter greater than a cylindrical upper section of said stand.

12. The barrier tape holding device of claim 1, further comprising a pair of wheels being coupled to said bottom section of said stand, said wheels extending perpendicularly from a bottom surface of said bottom section of said stand.

13. The barrier tape holding device of claim 1, further comprising:
an upper angle iron being coupled to said head;
a lower angle iron being coupled to said head; and
wherein said upper angle iron and said lower angle iron are positioned such that said head is configured for being engaged directly to an I-beam.

14. The barrier tape holding device of claim further comprising:
a platform coupled to and extending laterally from said stand; and
a ring coupled to and extending laterally from said stand, said ring being positioned vertically aligned above said platform wherein said ring is configured for encircling a fire extinguisher positioned on said platform.

15. The barrier tape holding device of claim 1, further comprising a handle coupled to and extending laterally relative to said stand.

16. The barrier tape holding device of claim 15, further comprising said handle including a pair of grips, said grips being linearly aligned and extending from opposite sides of said stand bracket.

17. The barrier tape holding device of claim 4, further comprising a pair of hooks, each of said hooks being coupled to and extending from said head, said pair of hooks being positioned adjacent to a respective one of said first end of said first channel and said primary end of said second channel.

18. The barrier tape holding device of claim 4, further comprising said head bracket being positioned between said first channel and said second channel.

19. A barrier tape holding device comprising:
a stand, said stand having a hollow interior space, said stand having a top opening, said top opening being in fluid communication with said hollow interior space wherein said top opening is configured for insertion of weighting material into said hollow interior for weighting said stand, a bottom section of said stand being conical, said hollow interior space having a cylindrical lowermost section positioned adjacent to and extending upwardly from a bottom section of said stand, said lowermost section of said hollow interior space having a diameter greater than a cylindrical upper section of said stand;
a jar, said jar being securable to said top opening for closing said top opening;
a stand bracket coupled to said stand;
a head removably coupled to said stand bracket;
a first channel extending laterally into and through said head, said first channel having a narrowing section such that a first end of said first channel is wider than a second end of said first channel, said first channel having a straight section defined by parallel surfaces extending from said narrowing section of said first channel;
a first block, said first block being insertable into said first end of said first channel, said first block having a maximum width greater than a width of said second end of said first channel wherein said first block is configured for being wrapped with a first barrier tape extending into and through said first channel whereby insertion of said first block into said first channel is configured to secure the first barrier tape to said head, said first block having a triangular cross-sectional shape perpendicular to a longitudinal axis of said first block;
a first tether coupled between said first block and said head;
a second channel extending laterally into and through said head, said second channel having a second channel narrowing section such that a primary end of said second channel is wider than a secondary end of said second channel, said second channel having a straight section defined by parallel surfaces extending from said second channel narrowing section of said second channel, said head bracket being positioned between said first channel and said second channel;
a second block, said second block being insertable into said primary end of said second channel, said second block having a maximum width greater than a width of said secondary end of said second channel wherein said second block is configured for being wrapped with a second barrier tape extending into and through said second channel whereby insertion of said second block into said second channel is configured to secure the second barrier tape to said head, said second block having a triangular cross-sectional shape perpendicular to a longitudinal axis of said second block;
a magnet being positioned within said head, wherein said head is configured for magnetic connection to a metal support structure;
a bolt being threaded through said head bracket wherein said bolt is configured for tightening onto the support structure when the support stricture is positioned within said head bracket;
a pair of wheels being coupled to said bottom section of said stand, said wheels extending perpendicularly from a bottom surface of said bottom section of said stand;
an upper angle iron being coupled to said head;
a lower angle iron being coupled to said head, wherein said upper angle iron and said lower angle iron are positioned such that said head is configured for being engaged directly to an I-beam;
a platform coupled to and extending laterally from said stand;
a ring coupled to and extending laterally from said stand, said ring being positioned vertically aligned above said platform wherein said ring is configured for encircling a fire extinguisher positioned on said platform;
a handle coupled to and extending laterally relative to said stand, said handle including a pair of grips, said grips being linearly aligned and extending from opposite sides of said stand bracket; and
a pair of hooks, each of said hooks being coupled to and extending from said head, said pair of hooks being positioned adjacent to a respective one of said first end of said first channel and said primary end of said second channel.
